(19) United States
(12) Patent Application Publication
(10) Pub. No.: US 2003/0196454 A1
(43) Pub. Date: Oct. 23, 2003

(54) Multifunctional automatic switchable heat-insulating glass and air-conditioning method

(75) Inventor: Ping Jin, Nagoya-shi (JP)

Correspondence Address: SUGHRUE MION, PLLC, 2100 PENNSYLVANIA AVENUE, N.W., WASHINGTON, DC, 20037, US

(73) Assignee: NATIONAL INSTITUTE OF ADVANCED INDUSTRIAL SCIENCE AND TECHNOLOGY

(21) Appl. No.: 10/397,235

(22) Filed: Mar. 27, 2003

(30) Foreign Application Priority Data
Apr. 22, 2002 (JP) 2002-119105

(51) Int. Cl. C03C 15/00

(52) U.S. Cl. 65/30.11

(57) ABSTRACT

A glass substrate a vanadium dioxide-based switchable film and a visible-light anti-reflection film. The vanadium dioxide-based switchable film and said visible-light anti-reflection film are coated on to the glass substrate. The vanadium dioxide-based switchable film has a switching temperature set approximately at a proper temperature or a target air-conditioning temperature to be controlled in an interior space in contact with said glass, thereby providing a solar switching and heat-insulating functions to said glass.

### FIELD OF THE DISCLOSURE

The present disclosure teaches techniques related to multifunctional automatic solar switchable and heat-insulating glass having both an automatic solar switching function and a heat-insulating function. Specifically, a new multifunctional automatic solar switchable and heat-insulating glass capable of additionally providing an UV-shielding function and an environmental-cleaning function to a glass is provided. Such a glass is coated with a vanadium dioxide-based solar switchable film and visible-light anti-reflection films which could also be IR reflecting films. Techniques cover the solar switching and heat-insulation itself as well as an air-conditioning method using the solar switching and heat-insulation glass. The disclosed teachings provide several advantageous applications in many field including houses, buildings, automobiles and other moving vehicles. These advantages include, but not limited to, simultaneously achieving a plurality of functions, such as energy saving, increased level of comfort, easier environmental cleanup.

### BACKGROUND

Generally, vanadium dioxide (VO2) exhibits a thermochromic property due to a semiconductor-to-metal phase transition at 68° C. The above-mentioned thermochromic property is a thermally induced and reversible change of optical property. This transition temperature can be lowered by adding a specific metal or non-metal element such as tungsten (W). Conventionally, researches have been focused on utilizing vanadium dioxide as window coating materials for automatically controlling sunlight in response to environmental temperature. For a detailed discussion, see S. M. Babulanam, T. S. Eriksson, G. A. Niklasson and C. G. G. Granqvist: Solar Energy Materials, 16(1987) 347.

Vanadium dioxide-based switchable window material provides several advantages in terms of structural simplicity, large infrared-light modulation range, and stable transparency to visible light even in a switched state. The term “vanadium dioxide-based switchable material” herein means any switchable material based on vanadium dioxides including a vanadium dioxide containing material one or more elements for controlling its transition temperature or other transition properties. The conventional vanadium dioxide-based switchable materials, however, have serious disadvantages. They provide only a poor light transmittance in the visible light range. Further, only a simple or fixed switching function is provided.

Conventionally a low-emission glass (Low-E glass, IR-reflecting glass) having a transparency to visible light and a function of reflecting infrared light or radiation (heat ray) is also known. The low-emission glass typically has multiple layers comprising at least one of a metal thin film such as Ag, Au, Cu, Pt or Al, or a metallic nitride thin film such as TiN, ZrN, HfN or CrN, or a transparent conductive oxide thin film; a protective thin film; and an anti-reflection thin film. For details, see, New Glass Handbook, Editorial Committee of New Glass Handbook, 1991, Maruzen. For example, the low-emission glass is used in buildings to block the streaming of sunlight in summer to reduce cooling load or to prevent the escape of indoor heating in winter to reduce heating load. In either case, the low-emission glass simply reflects heat rays, and does not provide a function of automatically switchable heat insulating in response to surrounding temperatures, for example, of positively introducing the solar light and heat as needed in winter or the like.

There has also been known a thermally switchable window coating material, such as a thermo-responsive switchable glass using a particular hydrogel. For details, see Haruo Watanabe: Solar Energy, 1997, Vol. 23, p 49. While this material exhibits an excellent switching performance, it causes white turbidity in glass when thermally switched. Such a turbidity considerably reduces transparency, making the outside invisible. Thus, it is difficult to use such a material for windows in buildings. Particularly such a material can not be used for movable bodies such as automobiles, that requires a stable clear visibility.

A titanium oxide-based (TiO2, TiO2 plus additional element(s)) photocatalyst has various functions such as antifouling, anti-bacteria, odor elimination and environmental cleanup. For further details, see Industrial Materials, June 1999. However, the photocatalyst cannot exhibit any thermochromic switchable function.

### SUMMARY

To overcome some of the disadvantages noted above, the disclosed teachings provide a multifunctional automatic solar switchable and heat-insulating glass comprising a glass substrate a vanadium dioxide-based switchable film and a visible-light anti-reflection film. The vanadium dioxide-based switchable film and said visible-light anti-reflection film are coated on to the glass substrate. The vanadium dioxide-based switchable film has a switching temperature set approximately at a proper temperature or a target air-conditioning temperature to be controlled in an interior space in contact with said glass, thereby providing a solar switching and heat-insulating functions to said glass.

In a specific enhancement the visible-light anti-reflection film is made of titanium oxide-based material.

In a specific enhancement the vanadium dioxide-based switchable film is made of material selected from the group consisting of vanadium dioxide, vanadium dioxide including additional metal element, vanadium dioxide including additional non-metal, and vanadium dioxide containing additional compound.

In another specific enhancement the glass further includes a heat-ray reflecting (or heat insulation) layer to form a multilayered structure together with said switchable film and said anti-reflection film.

In yet another specific enhancement the glass contains a heat-ray reflecting (or heat insulation) material added thereto.

In still another enhancement the switching temperature of said switchable film is set approximately at a target heating temperature to be controlled in said interior space in contact with said glass, whereby said glass is operable responsive to an actual temperature of said interior space lower than said switching temperature to transmit solar heat from outside, and said glass is operable responsive to an actual temperature of said interior space higher than said switching temperature to transmit visible light and reflect heat generated by a heater toward said interior space.

In still another enhancement the switching temperature of said switchable film is set approximately at a target cooling temperature to be controlled in said interior space in contact with said glass, whereby said glass is operable responsive to an actual temperature of said interior space higher than said switching temperature to block solar heat from outside.

In still another enhancement the switching temperature of said switchable film is set at a given comfort temperature, whereby said glass is operable responsive to an actual temperature of said interior space lower than said switching temperature to automatically transmit solar heat from outside therethrough, and said glass is operable responsive to an actual temperature of said interior space higher than said switching temperature to automatically block solar heat from outside.

Another aspect of the disclosure is a structural member having solar switching and heat-insulating functions, comprising the multifunctional automatic switchable heat-insulating glass described above.

Yet another aspect of the disclosure is a method of switching a multifunctional automatic solar switchable and heat-insulating glass comprising setting switching temperature of a switchable film approximately at a target heating temperature to be controlled in an interior space in contact with said glass. the glass operably responds to an actual temperature of said interior space lower than said switching temperature to transmit solar heat from outside. The glass operably responds to an actual temperature of said interior space higher than said switching temperature to transmit visible light and reflect heater-heat toward said interior space.

Still another aspect of the disclosure is a method of switching the multifunctional automatic solar switchable and heat-insulating glass comprising setting switching temperature of a switchable film approximately at a target cooling temperature to be controlled in said interior space in contact with said glass. The glass operably responds to an actual temperature of said interior space higher than said switching temperature to block solar heat from outside.

Still another aspect of the disclosure is a method of air-conditioning an interior space using a multifunctional automatic solar switchable and heat-insulating glass comprising: setting a switching temperature of a switchable film approximately at a target air-conditioning temperature to be controlled in said interior space in contact with said glass. The glass operably responds during heating to an actual temperature of said interior space lower than said switching temperature to transmit solar heat from outside. The glass operably responds during heating to an actual heating temperature of said interior space higher than said switching temperature to transmit visible light therethrough and block the release of heater-heat to outside. The glass opearably responds during cooling, to an actual temperature of said interior space higher than said switching temperature to block solar heat from outside.

Yet another aspect of the disclosure is an air-conditioning system comprising a glass substrate, a vanadium dioxide-based switchable film, a visible-light anti-reflection film, and an air-conditioning apparatus operable to automatically control a temperature of an interior space in contact with said glass at a given value. The vanadium dioxide-based switchable film and said visible-light anti-reflection film are coated on to the glass substrate. The vanadium dioxide-based switchable film has a switching temperature set approximately at a target air-conditioning temperature to be controlled in an interior space in contact with said glass, thereby providing a solar switching and heat-insulating functions to said glass. The switching temperature of said switchable film is set approximately at said given air-conditioning temperature to be controlled in said interior space in contact with said glass.

In a specific enhancement the glass is operable responsive to the temperature of said interior space lower than said switching temperature to transmit solar heat from outside therethrough, and is operable responsive to the temperature of said interior space higher than said switching temperature to transmit visible light therethrough and block the release of heater-heat to outside. During a cooling operation of said air-conditioning apparatus, said glass is operable responsive to the temperature of said interior space higher than said switching temperature to block solar heat from outside.

### BRIEF DESCRIPTION OF THE DRAWING

The above objectives and advantages of the present invention will become more apparent by describing in detail preferred embodiments thereof with reference to the attached drawings in which:

FIG. 1 is a schematic diagram showing the typical structure and functions of a multifunctional, automatic solar switchable heat-insulating glass according to one embodiment of the present invention, wherein the glass has a TiO2/VO2/TiO2 three-layered structure formed on a single glass substrate.

FIG. 2 is a diagram showing the relationship between a visible-light transmittance (Tlum) and the thickness of a TiO2 (d1)/VO2 (50 nm) TiO2 (d2) multilayered structure calculated by an anti-reflection coating theory.

FIG. 3 is a diagram showing respective variations of a spectral transmittance (a) and a spectral reflectance (b) before and after the phase transition (before and after switching) in two multifunctional automatic switchable heat-insulating glasses that is disclosed herein, where one of the glasses has a VO2 layer formed on a silica glass substrate, and the other glass has a TiO2/VO2/TiO2 (25 nm/50 nm/25 nm) three-layered structure formed on the silica glass substrate.

FIG. 4 is a diagram showing a spectral transmittance and a spectral reflectance of a conventional heat-ray reflection glass having a TiO2/TiN/TiO2 (30 nm/30 nm/30 nm) three-layered structure formed on the silica glass substrate.

### DETAILED DESCRIPTION

The disclosed teachings are discussed in further details below.

A vanadium dioxide-based switchable material and a visible-light anti-reflection material, or a combination of anti-reflection materials, are coated on a glass substrate in an appropriate order and at appropriate thicknesses to form a vanadium dioxide-based switchable film and visible-light anti-reflection films on the glass substrate. This vanadium dioxide-based switchable film has a switching temperature set approximately at a target, for example, the air-conditioning temperature to be controlled in an interior space in contact with the glass. In a specific enhancement, the vanadium dioxide-based switchable film contains a specific additional element such as tungsten to set the switching temperature approximately at a comfortable air conditioning temperature of the interior space (e.g. 22° C.) or at a temperature slightly lower than the air conditioning temperature. Japanese Patent Laid-Open Publication No. H07-331430, a method of preparing a thermochromic material and Japanese Patent Laid-Open Publication No. H08-3546, a method of preparing a thermochromic material provide further details on preparing the thermochromic material.

The visible-light anti-reflection film that is used in the disclosed teachings that is to be formed on the glass substrate together with the vanadium dioxide-based switchable film may be made of a compound such as TiO2, Al2O3, ZrO2, SiO2, ZnO:Al or SiN. More preferably, a titanium oxide-based photocatalyst thin film is used as the visible-light anti-reflection film. However, the disclosed teachings is not limited to these materials, but any other suitable material that provide substantially the same functions as that of the above compounds may be used. The titanium oxide-based photocatalyst thin film can provide a photocatalyst function, such as antifouling, anti-bacteria, odor elimination, environmental cleanup, water repellency or hydrophilicity, and a UV-shielding function.

An optimum combination of film structures or film thicknesses of the multilayer comprising the vanadium dioxide-based switchable thin film and the visible-light anti-reflection material, such as TiO2, ZnO:Al, ZrO2, SiO2, Al2O3, or SiN, can be derived form an accurate optical calculation using the respective optical constants of the materials. These calculations are described in an Example described subsequently. It is understood that to provide a maximized visible-light anti-reflecting function to achieve the advantages described above, the combination or selection of materials may be arbitrarily designed. The considerations include achieving a most effective structure that provides a visible-light anti-reflection, or use of a multilayered film/its gradient composition or a thin film having a gradient structure. While the switching temperature of the vanadium dioxide-based switchable film is preferably set at a temperature (e.g. 20° C.) slightly lower than a target air conditioning temperature (e.g. 22° C.) by adding a specific element, the disclosed teachings are not limited to this manner. Notably, the switching temperature may be set at any level separately or in conjunction with an air-conditioning temperature.

In the disclosed teachings, the switching temperature of the vanadium dioxide-based switchable film can be controllably set at any level by adding a specific metal or non-metal element into vanadium dioxide. In this case, the addition of tungsten is significantly effective in controlling the switching temperature of the vanadium dioxide-based switchable film.

It is understood that the additional element is not limited to tungsten, but any other suitable metal or non-metal element such as Mo, Nb, Ta, F or N may be effectively added into vanadium dioxide to control the switching temperature. Further, in order to provide an enhanced heat-ray reflection function, a heat-ray reflection material such as Ag, Au, Cu, Al, N may be added into vanadium dioxide of the switchable thin film, or alternatively, conventional heat-ray reflection films, for example, Ag, TiN, ZnO:Al, may be introduced together with the switchable and the anti-reflection thin films.

In order to adjust color tone, a suitable element may be added to the switchable film, or a suitable thin film may be provided together with the switchable and the anti-reflection thin films. It is understood that any technique for improving the characteristics of titanium oxide photocatalyst may be applied to the titanium oxide-based thin film.

In the disclosed single insulating glass window structure, the thin films are typically formed on the surface of the glass substrate that faces the interior of the space. However, the thin films may be formed on the surface of the glass substrate that faces the outside for some applications. Further, in a double insulating glass window structure, the thin films may be formed on either or both of the opposite surfaces of inner and outer glasses. Still further, the thin films may be formed on the surface of the outer glass substrate that faces outside as well as surface of the inner glass substrate that faces the inside. That is, any targeting temperature of the switchable film and any position of the thin films to the glass may be selectively set or arranged based on the application.

A reactive sputtering technique may be used to prepare a tungsten-added vanadium dioxide thin film. In this case, a desired tungsten-added vanadium dioxide thin film may be prepared by reactive-sputtering using a vanadium alloy target containing a given amount of tungsten or a multiple-simultaneous sputtering using a tungsten target and a vanadium target. The visible-light anti-reflection film may also be prepared by a sputtering technique.

A titanium oxide-based visible-light anti-reflection/photocatalyst thin film may be formed by a reactive sputtering technique using a titanium metal target or a sputtering technique using a titanium oxide ceramic target. In this case, a suitable element may be effectively added to provide enhanced photocatalyst characteristics. In such a case, a desired crystal phase can be obtained by accurately controlling the sputtering conditions. While the sputtering technique has been described as one example of the method of preparing the thin films, the disclosed teachings are not limited to a specific technique, but any other suitable technique capable of providing a desired structure and properties of the thin film materials disclosed herein may be effectively used. Examples of techniques that may be used include, vacuum evaporation deposition technique, a sol-gel technique, a CVD technique, etc.

As described above, in disclosed teachings, the vanadium dioxide-based switchable film and the visible-light anti-reflection film are coated on the glass substrate. In this case, the titanium oxide photocatalyst thin film used as the visible-light anti-reflection film can provide multiple combinations of several functions. These functions include, a high-performance automatic solar switchable and heat-insulating glass having a thermochromic automatic solar switching function, a heat insulation function, and photocatalyst functions such as antifogging, anti-bacterial function, odor elimination, improved environmental cleanup, water repellency or hydrophilicity, a harmful-UV shielding function, and a high visible transparency capable of stably maintaining a transparent view in both switched states.

A desired feature of the disclosed teachings is to provide automatic solar switching and heat insulating (or heat-ray reflecting) functions to the glass by setting and arranging the switching temperature of the switchable thin film and the position of the thin films.

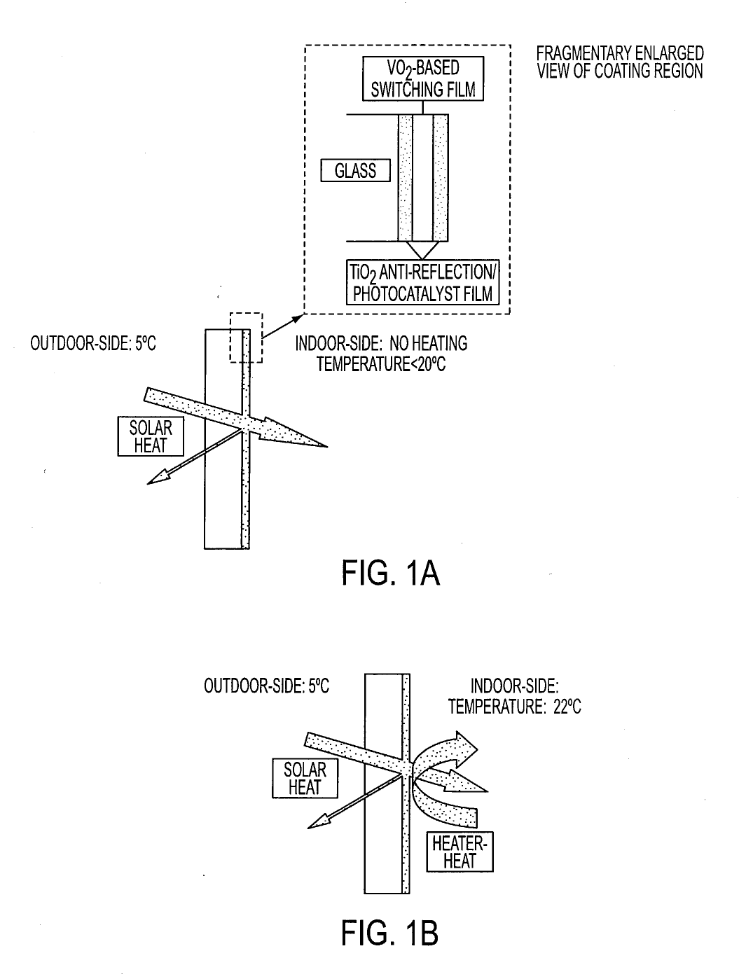

With reference to FIG. 1, the structure and function of a multifunctional automatic solar switchable and heat-insulating glass embodying some features of the disclosed teachings will be schematically described. While the following description will be made in conjunction with one embodiment having a TiO2/VO2/TiO2 three-layered structure formed on a single glass substrate, it is understood that the structure of the multifunctional automatic solar switchable and heat-insulating glass is not limited to this embodiment. Any modification, such as the addition of elements for setting the switching temperature of the switchable film and/or improving heat-insulation (heat-reflection) characteristics, the use of materials other than TiO2 for the visible-light anti-reflection film, a protective film, and/or a reflection-color control film, or more effective multilayered structure, may be made without deviating from the spirit of the disclosed teachings.

The automatic solar switching and heat-insulating mechanism is first described in detail with reference to FIG. 1. The activation temperature of the switchable film is set at a temperature (e.g. 20° C.) slightly lower than a air conditioning temperature (e.g. 22° C.). In winter, the outdoor temperature is low, for example 5° C. In such a case, the temperature of the interior space becomes lower than 20° C. if no heater is generating heating. The switchable film can assume a semiconductor state to sufficiently transmit solar heat or solar energy therethrough and introduce it into the interior space [FIG. 1(A)]. Then, after the heater starts generating heat, the temperature of the interior space may be increased up to 22° C., and consequently the switchable film on the interior-space-facing surface of the glass substrate is automatically switched to a metal state. When this is done, visible light is transmitted but infrared-light and heat are reflected. Heat generated by the heater is prevented from being released therefrom during heating [FIG. 1(B)].

In summer, the ambient temperature is generally higher than 20° C. Even if an air-conditioning system is activated, its target cooling temperature is generally set at a temperature higher than 20° C. Thus, the switchable film can stably have the metal property to block solar and/or heat radiation from outdoor. In other seasons, the automatic solar switching and heat-insulating function can also be achieved in response to a pre-set comfort ambient temperature. If the titanium oxide-based film is used as the outermost layer, the photocatalyst effect can provide a plurality of environment purification functions in addition to the visible-light anti-reflecting effect.

The above embodiment has been described in conjunction with a single pane glass window. In a double pane glass window, at least one of the three coated structures can automatically control the transmission/reflection of sunlight and/or solar heat in response to the set switching temperature. These three coated structures of films include; one, the structure coated on the surface of an inner glass substrate facing inside, two, the structure coated on the surface of an outer glass facing outside, and three, the structure coated on at least one of the intermediate surfaces of the outer or inner glass. Thus, in the present invention, the position of the coatings can be selected according to need. Further, the switching temperature can also be at any value according to need.

An optimum structure of film thickness for maximizing the visible-light transmittance in the materials disclosed herein can be logically calculated through a “Transfer-Matrix” technique. This is described, for example, in detail in B. Harbecke: Appl. Phys, B39 (1985) 165. The respective optimum thickness of the layer materials can be determined by accurately calculating from the respective constants of vanadium dioxide, titanium oxide and others. This constants are provided, for example, in M. Tazawa, P. Jin, S. Tanemura: Applied Optics 32 (1998) 1858, (9) Handbook of Optical Constants of solids 1: Edward D. Palik, ed. Academic Press, (1998) 799].

Vanadium dioxide, metal-element-added vanadium dioxide, non-metal-element-added vanadium dioxide and compound-added vanadium dioxide may be used as materials to produce structure according to the disclosed teachings. For example, the tungsten-added vanadium dioxide may be prepared through a reactive sputtering technique, as described above. Specifically, a desired tungsten-added vanadium dioxide thin film may be prepared through reactive sputtering using a tungsten-vanadium alloy target or a multiple-simultaneous sputtering using a tungsten target and a vanadium target.

The visual-light anti-reflection film according to the disclosed teachings is coated on the glass substrate together with the vanadium dioxide-based switchable film. While a titanium oxide-based material is preferably used as the visual-light anti-reflection film, the disclosed teachings is not limited to this material, but any other suitable material having a similar or an equivalent effect to the titanium oxide-based material may be used. For example, a titanium oxide photocatalyst thin film may be formed through a reactive-sputtering technique using a titanium metal target or a sputtering technique using a titanium oxide ceramic target. In this case, a desired crystal phase can be obtained by accurately controlling sputtering conditions.

While the aforementioned sputtering technique used for preparing the thin films is one of the techniques suitable for uniformly coating a large window, the disclosed teachings is not limited to a specific technique, but any technique capable of providing the above-mentioned desired properties of the thin film materials may be used. These techniques include, but are not limited to, vacuum evaporation technique, a CVD technique or a sol-gel technique.

According to the disclosed teachings, a heat-ray reflection layer may be incorporated in the above multifunctional automatic solar switchable and heat-insulating glass to form a multilayered structure. Additionally, a heat-ray reflection material may be added to provide a heat-ray reflecting function to the glass. Further, the disclosed automatic solar switchable heat-insulating glass may be separately used or combined with an air-conditioning apparatus having a function of automatically controlling the temperature of an interior space in contact with the automatic switchable heat-insulating glass at a given value, to construct an air-conditioning system. In this case, the above air-conditioning apparatus is not limited to a specific type, but any suitable air-conditioning apparatus capable of automatically controlling the temperature of an interior space in contact with the automatic switchable heat-insulating glass may be used. Then, the switching temperature of the switching film may be set approximately at a target air-conditioning temperature to be controlled in the interior space in contact with the automatic switchable heat-insulating glass. The temperature is set so that the glass is operable responsive to an actual temperature of the interior space lower than the switching temperature to transmit solar heat from outside therethrough, and is operable responsive to an actual temperature of the interior space higher than the switching temperature to block solar heat from outside in summer or to block the room heating in winter, or to provide a air-conditioning system capable of air-conditioning at a target air-conditioning temperature with energy conservation effect. An additional functional device may also be appropriately combined with the multifunction automatic solar switchable and heat-insulating glass to construct the disclosed air-conditioning system. The air-conditioning system may be arbitrarily designed by selectively using the functional device.

As described above, the disclosed multifunctional automatic solar switchable and heat-insulating glass comprises the glass substrate, the vanadium dioxide-based switchable film, and the visible-light anti-reflection film. The vanadium dioxide-based switchable film and the visible-light anti-reflection film are coated on a given position of the glass substrate. Further, the vanadium dioxide-based switchable film has a switching temperature set separately or set approximately at a target air-conditioning temperature to be controlled in an interior space in contact with the glass, so as to provide solar switching and heat-insulating functions to the glass. This structure allows the glass to be simultaneously provided with a plurality of functions such as a solar switching function, a visible-light anti-reflecting function, a high visible-transmitting function, a heat-insulating function, a UV-shielding function and an environmental cleaning function. In addition, these switching, visible-light anti-reflecting and heat-insulating functions can be combined together to achieve a new air-conditioning method and system capable of efficiently air-conditioning a given internal space with energy conservation effect. During heating, for example, in winter, the switching temperature of the switching film can be set approximately at a target heating temperature to be controlled in an interior space in contact with the glass, so that the glass is operable responsive to the temperature of the interior space lower than the switching temperature to transmit solar heat from outside therethrough, and is operable responsive to the temperature of the interior space higher than the switching temperature to transmit visible light therethrough and reflect heater-heat toward the interior space. Further, during cooling, for example, in summer, the glass is operable responsive to the temperature of the interior space higher than the switching temperature to block solar heat from outside.

### EXAMPLE

While the disclosed teachings are specifically described in conjunction with the following Example, it is not limited to the Example.

### Example 1

(1) Method

In this Example, a general-purpose magnetron sputtering apparatus was used to prepare films. This apparatus can arrange up to three cathodes each of which can be arbitrarily power-controlled by a high-frequency power source or DC power source. The apparatus has a rotatable substrate holder, and the temperature of the substrate can be precisely set in the range of room temperature to 800° C. A commercially available vanadium target (V, φ 50 mm, purity: 99.9%), a commercially available tungsten target (W, φ 50 mm, purity: 99.9%) and a commercially available titanium oxide target (TiO2, φ50 mm, purity: 99.9%) were placed on the cathodes, respectively. After evacuating a vacuum system at 2.5×10-6 Pa or less, argon and oxygen gases were introduced into the chamber to form a film. The substrate temperature was set in the range of room temperature to 500° C. The substrate was selected from the group consisting of a silica glass substrate, silicon single crystal substrate, sapphire substrate and heat-resistant glass substrate.

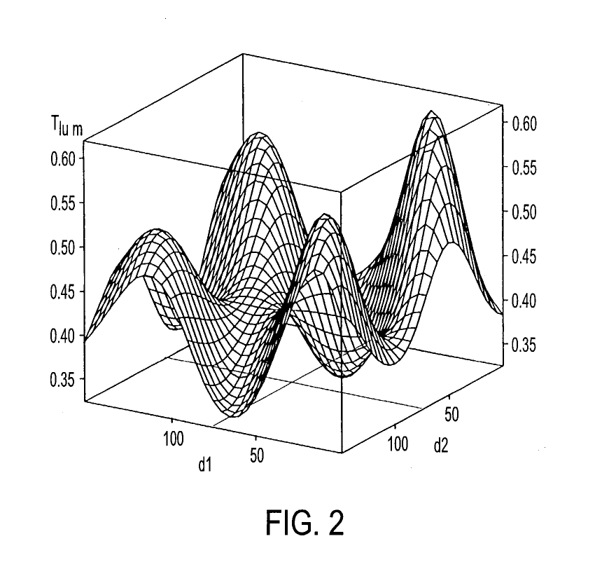

An optimum film thickness of a multilayered structure composed of TiO2/VO2/TiO2 to be formed on a glass substrate as one example of a structure including a vanadium dioxide-based switchable film and a titanium oxide-based visible-light anti-reflection film which are coated on a glass substrate was calculated by an anti-reflection coating theory using the properties and optical constants of the materials. As a result, it was verified that a maximum visible-light anti-reflection effect could be obtained when the thickness of the VO2 film was 50 nm, and each of the TiO2 film was 25 nm in common (FIG. 2).

Based on this result, the optimum structure was prepared through the aforementioned spattering method. For preparing the VO2 film, a radio-frequency power of 180 W was applied to the vanadium target, and sputtered under the conditions of a substrate temperature of 500° C., a total pressure of 0.6 Pa and an oxygen partial pressure of 7% to form a vanadium oxide thin film having a thickness of 50 nm. For preparing the tungsten-added VO2 thin film, a radio-frequency power of 10 to 40 W was applied to the tungsten target, and simultaneously sputtered it under the same conditions to form a tungsten-added vanadium dioxide thin film having a thickness of 50 nm.

In the same vacuum space, the titanium oxide was sputtered with radio-frequency power of 160 W under argon atmosphere to form two of titanium oxide films each having a thickness of 25 nm while sandwiching the vanadium oxide therebetween. The structure and composition of the obtained multilayered structure were evaluated through a X-ray diffraction technique and RBS.

The spectral transmittance and reflectance of each of samples having a multilayered thin film formed on a transparent substrate such as the silica or sapphire substrate were measured with a temperature-controllable spectrophotometer at 20° C. (vanadium dioxide-based semiconductor phase) and 80° C. (vanadium dioxide-based metal phase). Further, the temperature-dependent variation of the transmittance at a wavelength of 2000 nm was measured, and a switching temperature of the material was determined from the obtained transmittance-temperature curve.

(2) Result

FIG. 2 shows a combinational optimum film thickness obtained by calculating a visible-light transmittance of the multilayered structure through the anti-reflection coating theory using the optical constants of the VO2 and TiO2 thin films. It shows that when each of the TiO2 thin films in the TiO2/VO2/TiO2 structure has a thickness of 25 nm with respect to the VO2 switching thin film of thickness 50 nm, the visible-transmittance is increased from 36% to a maximum value of 62%. This proves that the visible-light transmittance has been developed to a practical level for application by the action of the visible-light anti-reflection film.

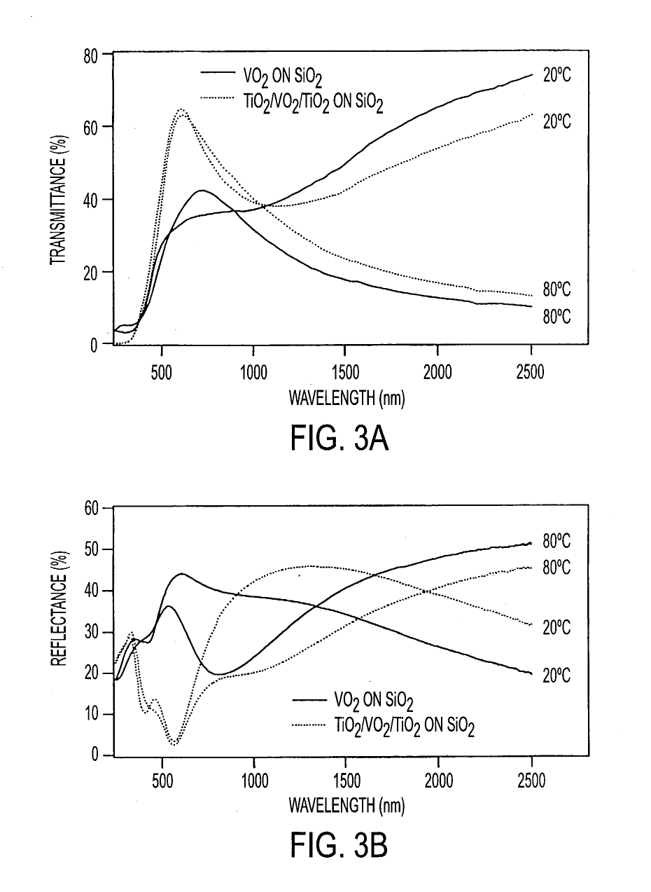

FIG. 3 shows a measurement result of respective variations in a spectral transmittance and a spectral reflectance before and after the phase transition (before and after switching) of a VO2 film and a TiO2/VO2/TiO2 (25 nm/50 nm/25 nm) structure which are formed on the transparent silica substrate using the sputtering technique. As seen in the visible light range, it is clear that the visible-light anti-reflecting function of the TiO2 layers provided a significantly enhanced light-transmittance. As seen in the infrared-light range, it is clear proved that the visible-light transmittance and the visible-light reflectance changed minimally before and after switching, while the infrared-light transmittance and the infrared-light reflectance changed sharply, and a high infrared-light switching effect having temperature dependence was exhibited. Further, in the infrared-light range, the infrared-light switching effect is clearly enhanced as wavelength is increased.

### Comparative Example 1

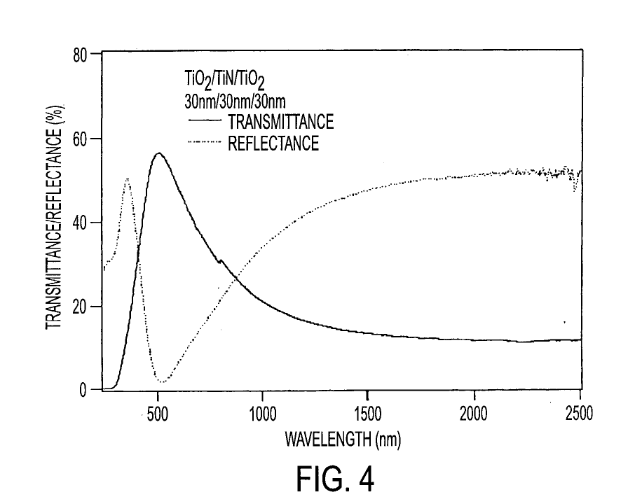

As the conventional heat-ray reflection glass, a sample composed of a silica glass substrate, and a TiO2/TiN/TiO2 (30 nm 30 nm/30 nm) structure formed on the substrate was prepared through the sputtering technique, and the sample was optically measured. FIG. 4 shows a spectrum transmittance and a spectrum reflectance of this sample. While this sample exhibits a typical heat-reflection characteristic of transmitting visible light and reflecting infrared light, it has no temperature-dependent switching characteristic.

As mentioned above in detail, the disclosure describes a multifunctional automatic solar switchable and heat-insulating glass far superior to the conventional heat-ray reflection and heat-insulating glass, and has the following significant advantages. The visible-light transmittance of the switchable film is significantly increased by use of the visible-light anti-reflection material. Even if the switchable film is switched according to its property, a high transparency is stably maintained. When a titanium-oxide photocatalyst film is used as the anti-reflection film, a plurality of functions such as a UV-shielding function of 95% or more and an environment cleaning function are provided. The switching temperature can be appropriately set to block the solar and/or hat radiation from outdoor in summer, and to automatically control the taking of sunlight into an interior space and the confinement of heater-heat within the interior space in winter in response to a air conditioning temperature (indoor temperature at heating). A desired function is obtained by a simple structure, and neither artificial energy nor additional equipment is required for the switching operation. The disclosed teachings provide a novel, revolutionary multifunctional automatic solar switchable and heat-insulating glass having integrated functions including an automatic solar switching and heat-insulation function, high visible transparent function, high UV-shielding function, various environmental cleaning functions and others. The glass can provide a plurality of additional functions such as energy saving, healthful comfortability and environmental cleanup to buildings and movable bodies such as automobiles, trains, watercrafts or airplanes. The new multifunctional automatic solar switchable and heat-insulating glass of the present invention can be expectedly applied in housing and building industries and others.

Other modifications and variations to the disclosed teachings invention will be apparent to those skilled in the art from the foregoing disclosure and teachings. Thus, while only certain embodiments of the invention have been specifically described herein, it will be apparent that numerous modifications may be made thereto without departing from the spirit and scope of the disclosure.

What is claimed is:

1. A multifunctional automatic solar switchable and heat-insulating glass comprising:
a glass substrate;
a vanadium dioxide-based switchable film; and
a visible-light anti-reflection film,
wherein said vanadium dioxide-based switchable film and said visible-light anti-reflection film are coated on to the glass substrate,
wherein said vanadium dioxide-based switchable film has a switching temperature set approximately at a proper temperature or a target air-conditioning temperature to be controlled in an interior space in contact with said glass, thereby providing a solar switching and heat-insulating functions to said glass.

2. The multifunctional automatic solar switchable and heat-insulating glass as in claim 1, wherein said visible-light anti-reflection film is made of titanium oxide-based material.

3. The multifunctional automatic solar switchable and heat-insulating glass as in claim 1, wherein the vanadium dioxide-based switchable film is made of material selected from the group consisting of vanadium dioxide, vanadium dioxide including additional metal element, vanadium dioxide including additional non-metal, and vanadium dioxide containing additional compound.

4. The multifunctional automatic switchable heat-insulating glass as in claim 1, further including a heat-ray reflecting (or heat insulation) layer to form a multilayered structure together with said switchable film and said anti-reflection film.

5. The multifunctional automatic solar switchable and heat-insulating glass as in claim 1 containing a heat-ray reflecting (or heat insulation) material added thereto.

6. The multifunctional automatic solar switchable and heat-insulating glass as defined in claim 1, wherein said switching temperature of said switchable film is set approximately at a target heating temperature to be controlled in said interior space in contact with said glass, whereby
said glass is operable responsive to an actual temperature of said interior space lower than said switching temperature to transmit solar heat from outside, and
said glass is operable responsive to an actual temperature of said interior space higher than said switching temperature to transmit visible light and reflect heat generated by a heater toward said interior space.

7. The multifunctional automatic solar switchable and heat-insulating glass as in claim 1, wherein said switching temperature of said switchable film is set approximately at a target cooling temperature to be controlled in said interior space in contact with said glass, whereby
said glass is operable responsive to an actual temperature of said interior space higher than said switching temperature to block solar heat from outside.

8. The multifunctional automatic switchable heat-insulating glass as in claim 1, wherein said switching temperature of said switchable film is set at a given comfort temperature, whereby
said glass is operable responsive to an actual temperature of said interior space lower than said switching temperature to automatically transmit solar heat from outside therethrough, and
said glass is operable responsive to an actual temperature of said interior space higher than said switching temperature to automatically block solar heat from outside.

9. A structural member having solar switching and heat-insulating functions, comprising the multifunctional automatic switchable heat-insulating glass as defined in claim 1.

10. A method of switching a multifunctional automatic solar switchable and heat-insulating glass comprising:
setting switching temperature of a switchable film approximately at a target heating temperature to be controlled in an interior space in contact with said glass;
the glass operably responding to an actual temperature of said interior space lower than said switching temperature to transmit solar heat from outside; and
the glass operably responding to an actual temperature of said interior space higher than said switching temperature to transmit visible light and reflect heater-heat toward said interior space.

11. A method of switching the multifunctional automatic solar switchable and heat-insulating glass comprising:
setting switching temperature of a switchable film approximately at a target cooling temperature to be controlled in said interior space in contact with said glass;
the glass operably responding to an actual temperature of said interior space higher than said switching temperature to block solar heat from outside.

12. A method of air-conditioning an interior space using a multifunctional automatic solar switchable and heat-insulating glass comprising:
setting a switching temperature of a switchable film approximately at a target air-conditioning temperature to be controlled in said interior space in contact with said glass;
the glass is operably responding during heating to an actual temperature of said interior space lower than said switching temperature to transmit solar heat from outside;
the glass operably responding during heating to an actual heating temperature of said interior space higher than said switching temperature to transmit visible light therethrough and block the release of heater-heat to outside;
the glass opearably responding during cooling, to an actual temperature of said interior space higher than said switching temperature to block solar heat from outside.

13. An air-conditioning system comprising:
a glass substrate;
a vanadium dioxide-based switchable film;
a visible-light anti-reflection film; and
an air-conditioning apparatus operable to automatically control a temperature of an interior space in contact with said glass at a given value,
wherein said vanadium dioxide-based switchable film and said visible-light anti-reflection film are coated on to the glass substrate,
wherein said vanadium dioxide-based switchable film has a switching temperature set approximately at a target air-conditioning temperature to be controlled in an interior space in contact with said glass, thereby providing a solar switching and heat-insulating functions to said glass,
and wherein
said switching temperature of said switchable film is set approximately at said given air-conditioning temperature to be controlled in said interior space in contact with said glass.

14. The air-conditioning apparatus of claim 13, wherein said glass is operable responsive to the temperature of said interior space lower than said switching temperature to transmit solar heat from outside therethrough, and is operable responsive to the temperature of said interior space higher than said switching temperature to transmit visible light therethrough and block the release of heater-heat to outside; and
during a cooling operation of said air-conditioning apparatus, said glass is operable responsive to the temperature of said interior space higher than said switching temperature to block solar heat from outside.
